(19) United States
(12) Patent Application Publication
(10) Pub. No.: US 2020/0337097 A1
(43) Pub. Date: Oct. 22, 2020

(54) COMMUNICATION CONTROL METHOD, CONTROL SYSTEM AND ACCESSORY, AND COMPUTER-READABLE STORAGE MEDIUM

(71) Applicant: SZ DJI TECHNOLOGY CO., LTD., Shenzhen (CN)

(72) Inventor: Yi HAO, Shenzhen (CN)

(21) Appl. No.: 16/919,811

(22) Filed: Jul. 2, 2020

Related U.S. Application Data
(63) Continuation of application No. PCT/CN2018/071677, filed on Jan. 5, 2018.

(51) Int. Cl. H04W 76/11; H04W 76/15; H04W 76/18

(52) U.S. Cl. CPC H04W 76/11; H04W 76/18; H04W 76/15

(57) ABSTRACT

A communication control method includes receiving a first identifier and a second identifier sent by an accessory, assigning a third identifier for communication for the accessory based on the first identifier and the second identifier, and sending the third identifier to the accessory to enable the accessory to communicate in a network using the third identifier.

### CROSS-REFERENCE TO RELATED APPLICATION

This application is a continuation of International Application No. PCT/CN2018/071677, filed on Jan. 5, 2018, the entire content of which is incorporated herein by reference.

### TECHNICAL FIELD

The present disclosure relates to the field of communication technology and, more specifically, to a communication control method, control system and accessory, and a computer-readable storage medium.

### BACKGROUND

With the increasing selections of smart electronic products, the functions of the smart electronic products are becoming more and more power. However, for different users, the functional requirements of the smart electronic products are also different. Removable and a wide variety of accessories are the basis of rich functions. Users can achieve the needs for one or more functions by adding accessories in the smart electronic product system. In addition, users can also remove accessories that are not being used or used infrequently to enhance portability.

In the process of network communication of the electronic product system, accessories generally use device identifiers to communicate, and the same type of accessories generally have the same device identifier. For example, in a gimbal system, the device identifiers of all handles are the same, and the device identifiers for all follow-focus devices are the same.

However, in the specific application scenarios, the accessories of the electronic product system are also moving toward the direction of integrating more function and providing multiple working modes. As such, the same type of accessories may have different functions. When the same type of accessories are communicating using the device identifier, the communication logic can be confusing and function conflict can occur between the accessories.

### SUMMARY

In accordance with the disclosure, there is provided a communication control method including receiving a first identifier and a second identifier sent by an accessory, assigning a third identifier for communication for the accessory based on the first identifier and the second identifier, and sending the third identifier to the accessory to enable the accessory to communicate in a network using the third identifier.

Also in accordance with the disclosure, there is provided a communication control method including sending a first identifier and a second identifier of an accessory to a control system by broadcasting, receiving a third identifier assigned to the accessory sent by the control system, and communicating with the control system based on the third identifier.

Also in accordance with the disclosure, there is provided a control system including a transceiver configured to communicate with an accessory, and a processor configured to receive, through the transceiver, a first identifier and a second identifier sent by the accessory, assign a third identifier for communication for the accessory based on the first identifier and the second identifier, and send the third identifier to the accessory through the transceiver to enable the accessory to communicate in a network using the third identifier.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a communication control method according to an embodiment of the present disclosure.

FIG. 2 is a flowchart of a communication control method according to another embodiment of the present disclosure.

FIG. 3 is a flowchart of a communication control method according to another embodiment of the present disclosure.

FIG. 4 is a flowchart of a communication control method according to another embodiment of the present disclosure.

FIG. 5 is a flowchart of a communication control method according to another embodiment of the present disclosure

FIG. 6 is a structural diagram of a control system according to an embodiment of the present disclosure.

FIG. 7 is a structural diagram of an accessory according to an embodiment of the present disclosure.

FIG. 8 is a structural diagram of a system according to an embodiment of the present disclosure.

FIG. 9 is a structural diagram of a gimbal according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure. In the situation where the technical solutions described in the embodiments are not conflicting, they can be combined

It should be noted that, when a component is described as “fixed to” another component, it can be directly on another component, or an intermediate component can be present. When a component is considered to be “connected” to another component, it can be directly connected to another component or an intermediate component can be present at the same time.

Unless otherwise defined, all the technical and scientific terms used herein are the same as the meanings generally understood by persons skilled in the technical field of the present disclosure. Herein, the terms used in the specification of the present disclosure are intended to describe specific embodiments, instead of limiting the present disclosure. The term “and/or” used herein includes any and all combinations of one or more related items listed.

In view of the communication logic confusion and the function conflict between the accessories when the accessories use the device identifier to communicate in the network, the present disclosure provides the following technical solution, which includes assigning different identifiers for communication to accessories of types having risk of function conflict based on information that can uniquely identify the accessories. Based on the assigned identifier for communication, the same type of accessories in the network can be grouped, such that when the same type of accessories have different functions in the network, the occurrence of communication logic confusion and function conflict between the accessories can be reduce.

The embodiments of the present disclosure are described below in detail in combination with the accompanying drawings. Without conflict, the following embodiments and the features in the embodiments can be combined with each other.

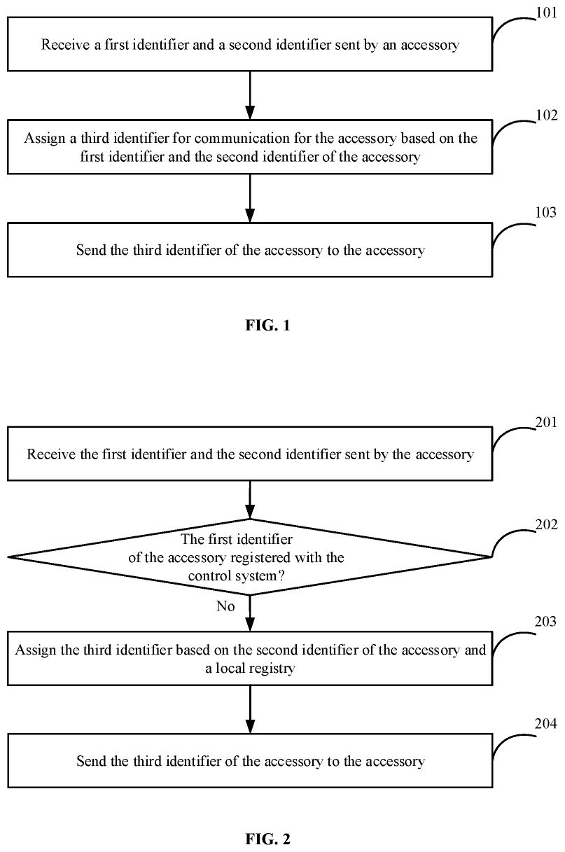

An embodiment of the present disclosure provides a communication control method. FIG. 1 shows a flowchart of a communication control method according to an embodiment of the present disclosure. The communication control method can be applied to a control system. In some embodiments, the control system may be a gimbal control system. The communication control method will be described in detail below.

101, receiving a first identifier and a second identifier sent by an accessory.

It should be noted that there may be a plurality of accessories. In order to describe more clearly, in the technical solutions of the present disclosure, the accessory pointed to by the first identifier and the second identifier received by the control system at the current time, as well as by other data being processed, is also referred to as a “target accessory” in this disclosure.

The first identifier of the accessory may be used to uniquely identify the accessory. For example, the first identifier may be a chip identifier of a chip of the accessory, or may be an encrypted identifier obtained by encrypting the chip identifier of the chip of the accessory. The chip may refer to a micro controller unit (MCU). In another example, the first identify may also be a product serial number that can uniquely identify the target accessory.

The second identifier of the accessory may be an identifier for indicating the type of accessory. For example, the second identifier of the accessory may be a device identifier of the accessory.

In some embodiments, the accessory may be a removable accessory.

In some embodiments, after connecting to the control system, the accessory may send the first identifier and the second identifier of the accessory to the control system in real time. The accessory may be connected to the control system through a wire or wirelessly. For example, the accessory may be connected to the control system through a controller area network (CAN) bus, and the accessory may also be connected to the control system by using low-power Bluetooth. For example, the accessory may broadcast the first identifier and the second identifier of the accessory to the control system. The control system may receive the first identifier and the second identifier sent by the accessory at fixed times. In some embodiments, real time described above may refer to a shorter period of time. For example, sending the first identifier and the second identifier of the accessory in real time may refer to sending the first identifier and the second identifier of the accessory again immediately after sending the first identifier and the second identifier of the accessory. In some embodiments, fixed times described above may refer to a longer period of time. In some other embodiments, real time and fixed times may also refer to the same period of time. In particular, the periods of time corresponding to the real time and the fixed times may be determined based on the specific needs. For example, the period of time corresponding to the fixed times may be less than or equal to the minimum time needed for the user to complete a plug-in operation of the accessory.

102, assigning a third identifier for communication for the accessory based on the first identifier and the second identifier of the accessory.

In an application scenario, the control system may determine whether a third identifier has been assigned to the target accessory based on the first identifier of the target accessory. In some embodiments, the control system may record the correspondence between the first identifier and the third identifier of the accessory after assigning the third identifier for communication to the accessory each time. After receiving the first identifier sent by the target accessory, the record may be queried to determine whether there is a correspondence between the first identifier and the third identifier of the target accessory. If the correspondence exist, it can be determined that the control system has assigned the third identifier to the target accessory; and if the correspondence does not exist, it can be determined that the control system has not assigned the third identifier to the target accessory.

In some embodiments, if the control system has assigned a third identifier for communication to the target accessory, the first identifier and the second identifier of the target accessory can be discarded, and the third identifier may no longer be assigned to the target accessory.

In some embodiments, if the control system has not assigned a third identifier for communication to the target accessory, a third identifier can be assigned to the target accessory for communication.

In some embodiments, the third identifier may be a temporary identifier. The third identifier for communication may be assigned to the accessory every time the accessory connects to the control system. The third identifier of the accessory assigned each time may be only used for the communication connection of the accessory this time. After the accessory is disconnected, the record of the first identifier and the third identifier of the accessory may be deleted.

In an application scenario, for some accessory types, only one accessory of a particular type may appear in the network, or even if multiple accessories of a particular type appear in the network, the functions of the multiple accessories may be the same, and thus there is no need to assign the third identifier to these types of accessories. In some cases, the network may include accessories of a same type but having different functions, and the third identifier may be assigned to these accessories. Based on this, in some embodiments, during the process of assigning the third identifier for the target accessory, the second identifier of the target accessory may be used to determine whether the target accessory is the type that needs to be assigned an identifier for communication. If the type of the target accessory does not need an identifier for communication, the control system may not assign a third identifier to the target accessory, and the accessory may use the second identifier to communicate in the network in the subsequent communications. If the type of the target accessory needs an identifier for communication, the control system may assign a third identifier to the target accessory. In some embodiments, the type of accessory that needs an identifier for communication may be defined in advance.

The third identifier for communication can be assigned to the target accessory in various manners, as described in more detail below.

In some embodiments, during the process of assigning the third identifier to the target accessory, the third identifier may be assigned to the target accessory in combination with the second identifier of the target accessory. Based on this, in some embodiments, the third identifier may include a main number and a sub-number, where the main number may be the second identifier of the target accessory, and the sub-number may be assigned by the control system to the target accessory in the type of target accessory. For example, the second identifier of the target accessory may be “1,” where “1” may represent a handle, and the identifier that can be assigned to the target accessory may be “1-3,” in which 1 may be the main number and 3 may be the sub-number. It should be noted that in the embodiments of the present disclosure, assigning a third identifier including a main number and a sub-number is merely an example, and other means of assigning the third identifier based on the second identifier of the accessory are also within the scope of the embodiments of the present disclosure, which are not repeated here.

In addition, the identifiers of the accessories used in the control system for communication may be different. Based on this, in some embodiments, during the process of assigning the third identifier for the target accessory, a third identifier under a type corresponding to the target accessory that is not assigned to other accessories may be assigned to the target accessory. For example, the system may include three handles at the time, and the third identifiers of the other two handles may be “1-1” and “1-2,” respectively. At this time, when the control system assigns the third identifier for communication for the current handle, the control system needs to ensure that the assigned third identifier does not conflict with the existing third identifiers of the other handles. For example, the third identifier that can be assigned to the current handle may be “1-3.”

103, sending the third identifier of the accessory to the accessory, such that the accessory uses the third identifier of the accessory to communicate in the network.

After the target accessory receives the third identifier sent by the control system, the target accessory may use the third identifier to communicate in the network formed by the system.

Consistent with the present disclosure, the control system may determine the type of the accessory based on the second identifier of the accessory. In combination with the first identifier, the control system may identify the accessory, and assign the third identifier for communication to the accessory based on the first identifier and the second identifier. During the communication in the network, when the accessories of the same type having different functions communicate in the same network, the possibility of communication logic and functional confusion can be reduced, and the user experience can be improved. As such, multiple accessories of the same type may be connected in the network and used with high compatibility, and the functions of the same types of accessories may not conflict with each other.

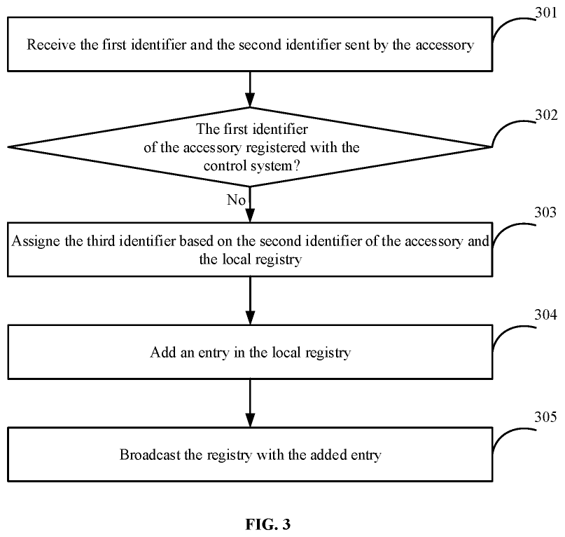

FIG. 2 is a flowchart of a communication control method according to another embodiment of the present disclosure. The communication control method will be described in detail below.

201, receiving the first identifier and the second identifier sent by the accessory.

The process at 201 is similar to the process at 101 described above, and the description thereof will not be repeated here.

202, determining whether the first identifier of the accessory is registered with the control system.

203, assigning the third identifier based on the second identifier of the accessory and a local registry if the first identifier is not registered with the control system.

The processes at 202 and 203 may be an example of the process at 102 described above.

The control system can maintain a local registry, and the registry may record the third identifiers assigned by the control system. More specifically, the registry may include a correspondence between the first identifier and the third identifier. For example, the first identifier can be a chip identifier and the third identifier can be a communication identifier, and the registry is shown in Table 1.

TABLE 1
Registry

| | |
|---|---|
| Chip identifier 1 | Communication identifier 1-1 |
| Chip identifier 2 | Communication identifier 1-2 |
| Chip identifier 3 | Communication identifier 2-1 |
| . . . | . . . |

In some embodiments, determining whether the first identifier of the accessory is registered with the control system (202) may be further include determining whether the first identifier of the target accessory is included in the local registry, determining that the first identifier is registered with the control system if the first identifier of the target accessory is included in the local registry, or determining that the first identifier is not registered with the control system if the first identifier of the target accessory is not included in the local registry.

In addition, the registry may also reflect the type of the accessory. More specifically, the registry may include the correspondence between the first identifier, the second identifier, and the third identifier. For example, the first identifier can be a chip identifier, the second identifier can be a device identifier, and the third identifier can be a communication identifier, and the registry is shown in Table 2.

TABLE 2
Registry

| | | |
|---|---|---|
| Device identifier 1 | Chip identifier 1 | Communication identifier 1-1 |
| | Chip identifier 2 | Communication identifier 1-2 |
| | . . . | . . . |
| Device identifier 2 | Chip identifier 3 | Communication identifier 2-1 |
| | . . . | . . . |

In some embodiments, an upper limit of the number of components of the same type in the network may be set. In some embodiments, assigning the third identifier based on the second identifier of the accessory and a local registry if the first identifier is not registered with the control system (203) may include the following processes.

Determine whether the number of all entries including the second identifier in the local registry has reached a threshold.

Discard the first identifier and the second identifier if the number of all entries including the second identifier in the local registry has reached the threshold. In this case, the target accessory may not be registered, and the third identifier may not be assigned to the target accessory.

Assign the third identifier based on the second identifier and the local registry if the number of all entries including the second identifier in the local registry has not reached the threshold. In some embodiments, the third identifier used for communication may be different from the identifiers used for communication in all entries including the second identifier in the local registry.

In some embodiments, the registry may also reflect the function permission of the accessory. More specifically, the registry may include the correspondence between the first identifier, the second identifier, the third identifier, and the function permission. For example, the first identifier is a chip identifier, the second identifier is a device identifier, and the third identifier is a communication identifier, and the registry is shown in Table 3.

TABLE 3
Registry

| | | | |
|---|---|---|---|
| Device | Chip identifier 1 | Communication | Handle function |
| identifier 1 | | identifier 1-1 | permission 1 |
| | Chip identifier 2 | Communication | Handle function |
| | | identifier 1-2 | permission 2 |
| | Chip identifier 3 | Communication | Handle function |
| | | identifier 1-3 | permission 3 |
| Device | Chip identifier 4 | Communication | Rocker function |
| identifier 2 | | identifier 2-1 | permission 1 |
| | . . . | . . . | . . . |
| . . . | . . . | . . . | . . . |

The function permission of the accessory may indicate which functions of the accessory are valid. In some embodiments, the function permission may correspond to different modes of the accessory. For example, the one-hand mode of the handle, the right-hand mode of the two-hand mode, or the left-hand mode of the two-hand mode. The function permission of the accessory may be set as needed. For example, the mode of the handle may be selected based on the actual needs, and the function permission may be determined based on the mode of the handle.

After the third identifier is assigned to the target accessory based on the first identifier and the second identifier, the method may further include adding an entry in the local registry to realize the registration of the first identifier. In some embodiments, the added entry may include the first identifier and the third identifier; the first identifier, the second identifier, and the third identifier; or the first identifier, the second identifier, the third identifier, and the function permission.

In some embodiments, the third identifier included in the added entry may be different from the third identifier included in other entries including the second identifier in the registry.

The functions of the same type of accessories in the network may be all the same, all different, or partially different. More specifically, the function permission of an accessory may be determined based on the actual needs. Based on this, in some embodiments, if the entry includes function permission, the added entry including the function permission may be different from the function permission included in other entries that include the second identifier in the local registry. In some other embodiments, if the entry includes function permission, the added entry may include the same or different function permission as the other entries that include the second identifier in the local registry.

It should be noted that the method of storing the registry is not limited in the embodiments of the present disclosure. For example, a registry including all registered accessories may be stored locally, or the accessories may be categorized based on the types of accessories, and each type may correspond to a registry.

204, sending the third identifier of the accessory to the accessory, such that the accessory uses the third identifier of the accessory to communicate in the network.

During implementation, there are various methods of sending the third identifier to the accessory.

In some embodiments, a registry including the third identifier of the accessory may be sent to the accessory, such that after the accessory receives the registry, the third identifier corresponding to the first identifier of the accessory can be acquired from the received registry.

It should be noted that the control system may store multiple registries locally. The control system may send the registry including the second identifier of the accessory to the accessory, or all the registries.

The process at 204 is similar to the process at 103 described above, and the detailed description thereof will not be repeated here.

FIG. 3 is a flowchart of a communication control method according to another embodiment of the present disclosure. The communication control method will be described in detail below.

301, receiving the first identifier and the second identifier sent by the accessory.

The process at 301 is similar to the process at 101 described above, and the detailed description thereof will not be repeated here.

302, determining whether the first identifier of the accessory is registered with the control system.

The process at 302 is similar to the process at 202 described above, and the detailed description thereof will not be repeated here.

303, assigning the third identifier based on the second identifier of the accessory and the local registry if the first identifier is not registered with the control system.

The process at 303 is similar to the process at 203 described above, and the detailed description thereof will not be repeated here.

304, adding an entry in the local registry, wherein the added entry includes the first identifier and the third identifier; the first identifier, the second identifier, and the third identifier; or the first identifier, the second identifier, the third identifier, and the function permission.

305, broadcasting the registry with the added entry.

The process at 305 is a specific example of the process at 103 described above.

The control system may broadcast the registry with the added entry, such that the accessories connected to the control system may receive the registry with the added entry. In some embodiments, the accessories connected to the control system may include the target accessory.

In addition, since there may be multiple registries stored in the control system, the control system may broadcast only the registry with the added entry or all the registries.

The target accessory may obtain the third identifier corresponding to the first identifier of the accessory from the registry with the added entry broadcasted by the control system. Subsequently, the target accessory may communicate with the control system based on the third identifier of the target accessory.

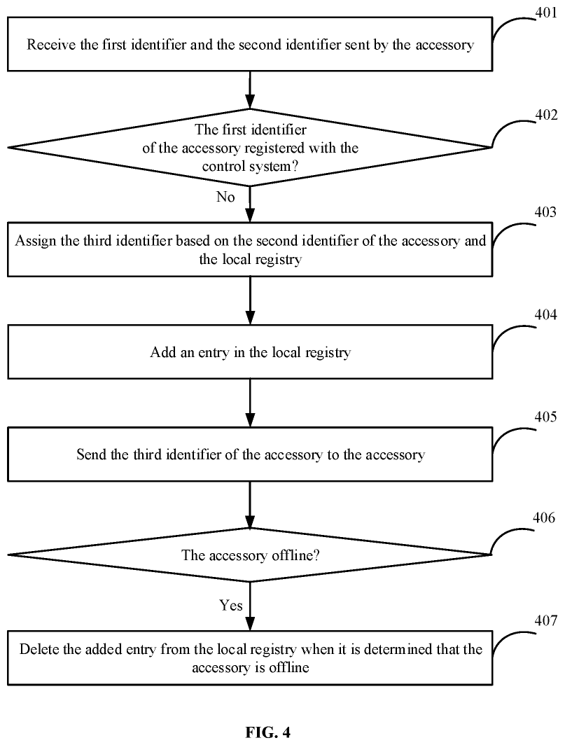

FIG. 4 is a flowchart of a communication control method according to another embodiment of the present disclosure. The communication control method will be described in detail below.

401, receiving the first identifier and the second identifier sent by the accessory.

The process at 401 is similar to 101 described above, and the detailed description thereof will not be repeated here.

402, determining whether the first identifier of the accessory is registered with the control system.

The process at 402 is similar to the process at 202 described above, and the detailed description thereof will not be repeated here.

403, assigning the third identifier based on the second identifier of the accessory and the local registry if the first identifier is not registered with the control system.

The process at 403 is similar to the process at 203 described above, and the detailed description thereof will not be repeated here.

404, adding an entry in the local registry.

The process at 404 is similar to the process at 304 described above, and the detailed description thereof will not be repeated here

405, sending the third identifier of the accessory to the accessory, such that the accessory uses the third identifier of the accessory to communicate in the network.

406, determining whether the accessory is offline.

In particular, there are various methods of determining whether the accessory is offline.

In some embodiments, since the accessory sends the first identifier and the second identifier of the accessory to the control system in real time, whether the accessory is offline may be determined based on the reception of the first identifier and the second identifier of the target accessory. More specifically, if the control system does not receive the first identifier and the second identifier sent by the target accessory within a set time, the control system may determine that the target accessory is offline. On the other hand, if the control system receives the first identifier and the second identifier sent by the target accessory within the set time, the control system may determine that the target accessory is not offline.

In some embodiments, the set time may refer to an integer multiple of the period corresponding to the fixed time described above. For example, if the control system fails to receive the first identifier and the second identifier sent by the target accessory in two consecutive periods corresponding to the fixed time, the control system may determine that the target accessory is offline.

407, deleting the added entry from the local registry when it is determined that the accessory is offline.

When it is determined that the target accessory is offline, the entry corresponding to the target accessory may be deleted from the local registry, that is, the entry corresponding to the first identifier of the target accessory may be deleted from the local registry.

Consistent with the present disclosure, the impact of hot swapping of accessories on communication can be reduced by detecting the connection state of the accessories. As such, during the communication process, the possibility of communication logic and functional confusion can be reduced, and the user experience can be improved.

In addition, the power supply or power-off of the accessories may be controlled based on the connection state of the accessories to ensure the stability of the power supply system. After the accessories are disconnected, the power supply of the accessories can be cut off quickly, which can reduce the occurrence of short circuit caused by the exposed connection point and improve the life of the accessories.

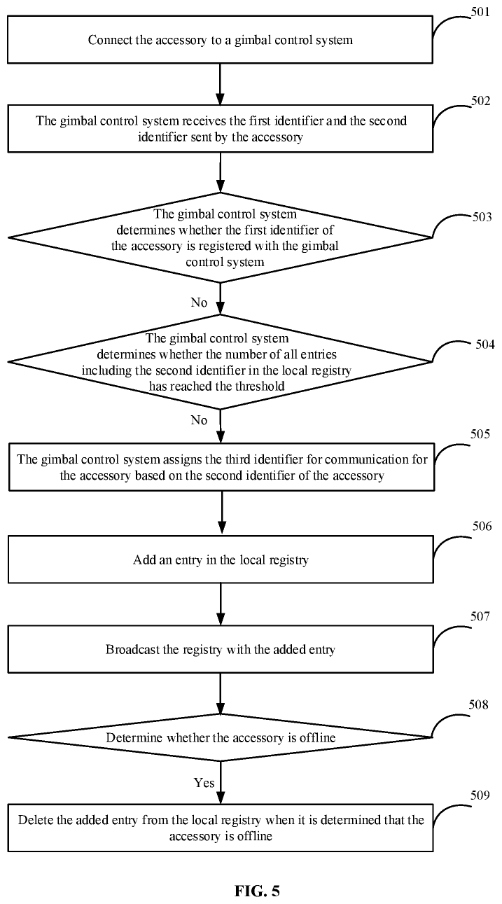

FIG. 5 is a flowchart of a communication control method according to another embodiment of the present disclosure. The communication control method will be described in detail below.

501, connecting the accessory to a gimbal control system.

In some embodiments, the accessory may be any of a gimbal handle, thumb follow-focus device, follow-focus device, rocker, somatosensory controller, wireless communication component, etc., and the accessories mentioned above may be connected to the gimbal control system through a wired connection or a wireless connection.

502, the gimbal control system receives the first identifier and the second identifier sent by the accessory.

The process at 502 is similar to the process at 101 described above, and the detailed description thereof will not be repeated here.

503, the gimbal control system determines whether the first identifier of the accessory is registered with the gimbal control system.

The process at 503 is similar to the process at 202 described above, and the detailed description thereof will not be repeated here.

Discarding the first identifier and second identifier of the accessory without assigning the communication identifier to the accessory if the first identifier is registered with the gimbal control system.

504, the gimbal control system determines whether the number of all entries including the second identifier in the local registry has reached the threshold if the first identifier is not registered with the control system.

Discarding the first identifier and second identifier of the accessory without assigning the communication identifier to the accessory if the number of all entries including the second identifier in the local registry has reached the threshold.

505, the gimbal control system assigns the third identifier for communication for the accessory based on the second identifier of the accessory if the number of all entries including the second identifier in the local registry has not reached the threshold, where the third identifier used for communication is different from the identifier used for communication in all entries including the second identifier in the local registry.

506, adding an entry in the local registry, where the added entry includes the first identifier, the second identifier, the third identifier, and the function permission.

The process at 506 is similar to the process at 304 described above, and the detailed description thereof will not be repeated here.

507, broadcasting the registry with the added entry.

The process at 507 is similar to the process at 305 described above, and the detailed description thereof will not be repeated here.

The target accessory may acquire the third identifier corresponding to the first identifier of the accessory from the registry with the added entry broadcasted by the control system.

508, determining whether the accessory is offline.

The process at 508 is similar to the process at 406 described above, and the detailed description thereof will not be repeated here.

509, deleting the added entry from the local registry when it is determined that the accessory is offline.

The process at 509 is similar to the process at 407 described above, and the detailed description thereof will not be repeated here.

FIG. 6 is a structural diagram of a control system according to an embodiment of the present disclosure. As shown in FIG. 6, the control system includes a transceiver 601, a processor 602, and a memory 603.

The memory 603 may be used to store program codes.

The transceiver 601 may be configured to communicate with the accessories. The transceiver 601 may be a wireless transceiver or a wired transceiver. In some embodiments, the transceiver 601 may include a receiver and a transmitter, and the receiver and the transmitter may be independent or integrated together.

The processor 602 may be configured to call the program codes. When the program codes are executed, the processor 602 may receive the first identifier and the second identifier sent by the accessory through the transceiver 601, assign the third identifier for communication to the accessory based on the first identifier and the second identifier, and assign the third identifier to the accessory through the transceiver 601, such that the accessory may use the third identifier to communicate in a network.

In some embodiments, the processor 602 may be configured to determine whether the first identifier has been registered with the control system and, if not, assign the third identifier based on the second identifier and the local registry.

In some embodiments, the processor 602 may be configured to determine whether the first identifier is included in the local registry; if so, determine that the first identifier is registered with the control system; if not, determine that the first identifier is not registered with the control system.

In some embodiments, the processor 602 may be configured to determine whether the number of all entries including the second identifier in the local registry has reached the threshold; if so, discard the first identifier and the second identifier; if not, assign the third identifier based on the second identifier and the local registry.

In some embodiments, the processor 602 may be configured to add an entry in the local registry, and the added entry may include the first identifier, the second identifier, and the third identifier.

In some embodiments, the processor 602 may be configured to broadcast the registry with the added entry through the transceiver 601.

In some embodiments, the processor 602 may be configured to determine whether the accessory is offline and, when it is determined that the accessory is offline, delete the entry from the local registry.

In some embodiments, the processor 602 may be configured to determine that the accessory is offline if the first identifier and the second identifier sent by the accessory are not received within the set time; or determine that the accessory is not offline if the first identifier and the second identifier sent by the accessory are received within the set time.

In some embodiments, the first identifier may be the chip identifier of a chip of the accessory, and the second identifier may be the identifier used to indicate the type of the accessory. The third identifier for communication may be different from the identifier used for communication in all entries including the second identifier in the local registry.

In some embodiments, the control system may include a gimbal control system.

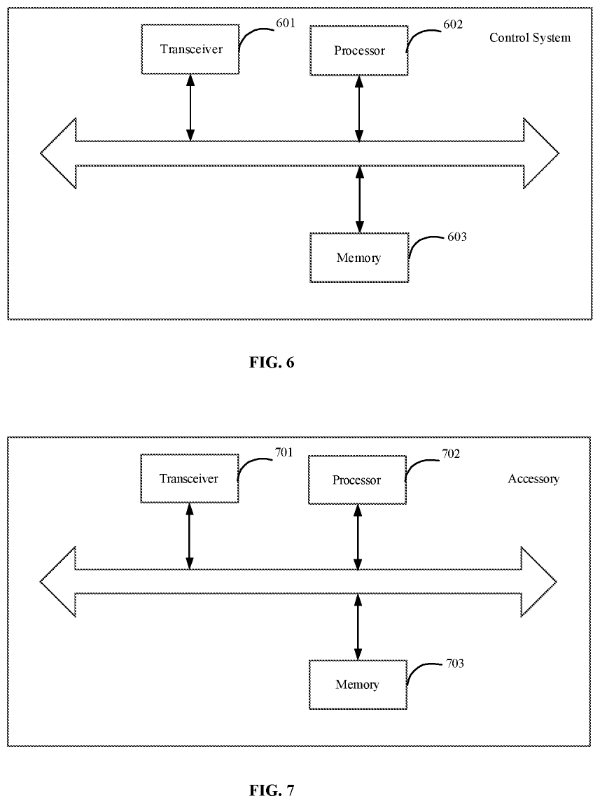

FIG. 7 is a structural diagram of an accessory according to an embodiment of the present disclosure. As shown in FIG. 7, the accessory includes a transceiver 701, a processor 702, and a memory 703.

The memory 703 may be used to store program codes.

The transceiver 701 may be configured to communicate with the control system. The transceiver 701 may be a wireless transceiver or a wired transceiver. In some embodiments, the transceiver 701 may include a receiver and a transmitter, and the receiver and the transmitter may be independent or integrated together.

The processor 702 may be configured to call the program codes. When the program codes are executed, the processor 702 may broadcast the first identifier and the second identifier of the accessory to the control system through the transceiver 701, receive the third identifier assigned by the control system for communication through the transceiver 701, and communicate with the control system based on the third identifier.

In some embodiments, the processor 702 may be configured to receive the registry broadcasted by the control system through the transceiver 701 and obtain the third identifier corresponding to the first identifier and the second identifier of the accessory from the registry.

In some embodiments, the first identifier may be the chip identifier of a chip of the accessory, and the second identifier may be the identifier used to indicate the type of the accessory. The third identifier for communication may be different from the identifier used for communication in all entries including the second identifier in the local registry.

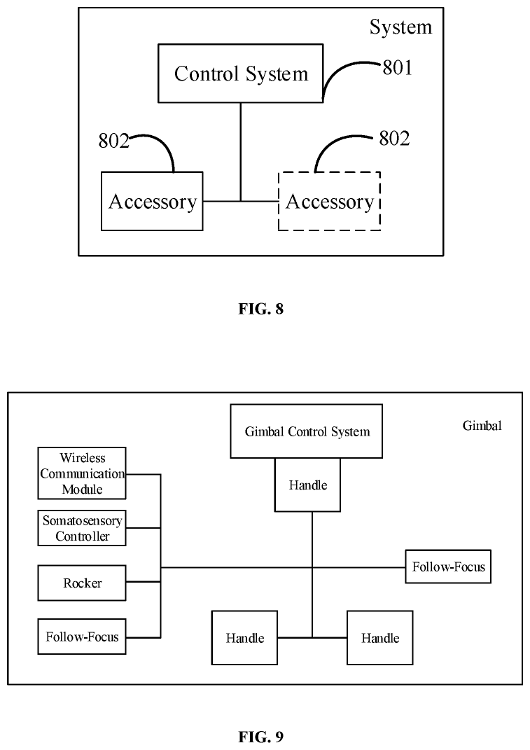

FIG. 8 is a structural diagram of a system according to an embodiment of the present disclosure. As shown in FIG. 8, the system includes a control system 801 and one or more accessories 802. The control system 801 may be any one of the control systems consistent with the disclosure, such as one of the above-described example control systems, and each of the one or more accessories 802 may include any one of the accessories consistent with the disclosure, such as one of the above-described example accessories.

In some embodiments, the system may include a gimbal. FIG. 9 is a structural diagram of a gimbal according to an embodiment of the present disclosure. As shown in FIG. 9, the gimbal includes a gimbal controller and a plurality of accessories. The plurality of accessories include three handles, two follow-focus devices, a rocker, a somatosensory controller, and a wireless communication device. In some embodiments, the three handles may be used in one-hand mode, right-hand mode in the two-hand mode, and left-hand mode in the two-hand mode. The absolute positions of the two follow-focus devices may be different. The controller may control the communication with the three handles and the two follow-focus devices by using any of the methods consistent with the disclosure, such as one of the above-described example methods.

The present disclosure further provides a computer-readable storage medium having computer instructions stored thereon. When the computer instructions is executed, the communication method corresponding to the control system described above can be performed.

The present disclosure further provides a computer-readable storage medium having computer instructions stored thereon. When the computer instructions is executed, the communication method corresponding to the accessory described above can be performed.

The system, device, module or unit described in the above embodiments may be realized using a computer chip or a physical entity, or a product having certain functions. A typical realization device is a computer. The detailed form of the computer may be a personal computer, a laptop computer, a cellular phone, a camera phone, a smart phone, a personal digital assistant, a multimedia player, a navigation device, an e-mail receiving and transmitting device, a game control console, a tablet computer, a wearable device, or any combination of two or more of these devices.

For the convenience of descriptions, the above devices are described based on functions being divided as various units. When implementing the present disclosure, functions of various units may be realized in one or multiple software programs and/or hardware components.

A person having ordinary skills in the art can appreciate, the present disclosure may be realized as a method, a system, or a computer program product. As such, the present disclosure may be realized using hardware alone, software alone, or a combination of software and hardware. In addition, the present disclosure may be realized as a computer program product implemented in one or more computer-readable storage media (including but not limited to a magnetic disk, a CD-ROM, an optical device, etc.) that store computer-executable program codes or instructions.

The present disclosure is described with reference to the flow charts and/or block diagrams of the disclosed methods, devices (systems), and computer program products. It should be understood that computer program codes or instructions may be used to realize each step and/or block included in the flow chart and/or block diagram, and a combination of the steps and/or blocks in the flow chart and/or the block diagram. Such computer program codes or instructions may be provided to a generic computer, a dedicated computer, an embedded processor, or a processor of a programmable data processing device to generate a machine, such that a device may be produced through the instructions executed by the computer or other processor of a programmable data processing device. The device may be used to realize a specified function of one or more steps in the flow chart and/or one or more blocks in the block diagram.

In addition, the computer program codes or instructions may be stored in a computer-readable storage medium that may guide a computer or other programmable data processing device to operate in a specified manner, such that instructions stored in the computer-readable storage medium generate a product having an instruction device. The instruction device may realize a specific function of one or more steps in the flow chart and/or one or more blocks of the block diagram.

The computer program codes or instructions may be loaded into a computer or other programmable data processing device, such that a series of steps may be executed on the computer or other programmable data processing device to generate a computer-realized process, such that the codes executed by the computer or other programmable data processing device may provide a step for realizing a specific function of one or more steps of the flow chart and/or one or more blocks of the block diagram.

The above described are only embodiments of the present disclosure, and are not intended to limit the scope of the present disclosure. A person having ordinary skills in the art can modify or change the embodiments of the present disclosure. Such modifications, equivalent substitutions, or improvements within the spirit and principle of the present disclosure all fall within the scope of the claims of the present disclosure.

What is claimed is:

1. A communication control method comprising:
receiving a first identifier and a second identifier sent by an accessory;
assigning a third identifier for communication for the accessory based on the first identifier and the second identifier; and
sending the third identifier to the accessory to enable the accessory to communicate in a network using the third identifier.

2. The method of claim 1, wherein assigning the third identifier based on the first identifier and the second identifier includes:
assigning the third identifier based on the second identifier and a local registry in response to the first identifier not being registered with the control system.

3. The method of claim 2, further comprising:
determining that the first identifier is registered with the control system in response to the first identifier being included in the local registry; or
determining that the first identifier is not registered with the control system in response to the first identifier not being included in the local registry.

4. The method of claim 2, wherein assigning the third identifier based on the second identifier and the local registry includes:
discarding the first identifier and the second identifier in response to a number of entries including the second identifier in the local registry reaching a threshold; and
assigning the third identifier based on the second identifier and the local registry in response to the number of entries including the second identifier in the local registry not reaching the threshold.

5. The method of claim 2, further comprising, after assigning the third identifier for the accessory based on the first identifier and the second identifier:
adding an entry in the local registry, the added entry including the first identifier, the second identifier, and the third identifier.

6. The method of claim 5, wherein the added entry further includes a function permission, the function permission included in the added entry being different from a function permission included in other entries including the second identifier in the local registry.

7. The method of claim 5, wherein sending the third identifier to the accessory includes:
broadcasting the registry with the added entry.

8. The method of claim 7, further comprising:
deleting the added entry from the local registry in response to determining the accessory is offline.

9. The method of claim 8, further comprising:
determining the accessory is offline in response to not receiving the first identifier and the second identifier sent by the accessory within a set time; or
determining the accessory is not offline in response to receiving the first identifier and the second identifier sent by the accessory within set time.

10. The method of claim 2, wherein:
the first identifier includes a chip identifier of a chip of the accessory;
the second identifier indicates a type of the accessory; and
the third identifier is different from an identifier used for communication in entries including the second identifier in the local registry.

11. The method of claim 1, wherein the control system includes a gimbal control system.

12. A communication control method comprising:
sending a first identifier and a second identifier of an accessory to a control system by broadcasting;
receiving a third identifier assigned to the accessory sent by the control system; and
communicating with the control system based on the third identifier.

13. The method of claim 12, wherein receiving the third identifier includes:
receiving a registry broadcasted by the control system; and
obtaining the third identifier corresponding to the first identifier and the second identifier of the accessory from the registry.

14. The method of claim 13, wherein:
the first identifier includes a chip identifier of a chip of the accessory;
the second identifier indicates a type of the accessory; and
the third identifier is different from an identifier used for communication in entries including the second identifier in the registry.

15. A control system comprising:
a transceiver configured to communicate with an accessory; and
a processor configured to:
receive, through the transceiver, a first identifier and a second identifier sent by the accessory;
assign a third identifier for communication for the accessory based on the first identifier and the second identifier; and
send the third identifier to the accessory through the transceiver to enable the accessory to communicate in a network using the third identifier.

16. The control system of claim 15, wherein the processor is further configured to:
assign the third identifier based on the second identifier and a local registry in response to the first identifier not being registered with the control system.

17. The control system of claim 16, wherein the processor is further configured to:
determine that the first identifier is registered with the control system in response to the first identifier being included in the local registry; or
determine that the first identifier is not registered with the control system in response to the first identifier not being included in the local registry.

18. The control system of claim 17, wherein the processor is further configured to:
discard the first identifier and the second identifier in response to a number of entries including the second identifier in the local registry reaching a threshold; and
assign the third identifier based on the second identifier and the local registry in response to the number of entries including the second identifier in the local registry not reaching the threshold.

19. The control system of claim 16, wherein the processor is further configured to:
add an entry in the local registry, the added entry including the first identifier, the second identifier, and the third identifier.

20. The control system of claim 19, wherein the added entry further includes a function permission, the function permission included in the added entry being different from a function permission included in other entries including the second identifier in the local registry.
